(19) United States
(12) Patent Application Publication
(10) Pub. No.: US 2026/0240359 A1
(43) Pub. Date: Aug. 20, 2026

(54) A TRAY ASSEMBLY FOR APPARATUSES FOR PREPARING COFFEE, MILK AND INFUSION-BASED BEVERAGES

(71) Applicant: DALLA CORTE S.R.L., BARANZATE DI BOLLATE (IT)

(72) Inventors: Paolo DALLA CORTE, NOVATE MILANESE (IT); Armando BAZZI, MILANO (IT)

(21) Appl. No.: 19/152,742

(22) PCT Filed: Feb. 14, 2024
(86) PCT No.: PCT/IB2024/051373

§ 371 Date: Jul. 31, 2025

(30) Foreign Application Priority Data
Feb. 22, 2023 (IT) 102023000003036

(51) Int. Cl. A47J 31/44

(52) U.S. Cl. CPC A47J 31/4482; A47J 31/4428

(57) ABSTRACT

A tray assembly for beverage apparatus for preparing and dispensing beverages. The tray assembly defines a support for cups and is configured for fluid collection and/or discharge and includes a tray having a body that houses a funnel with a discharge fitting and a grille disposed over the funnel. The tray assembly also includes a mechanical interface element for connection to the beverage apparatus, and a hydraulic coupling apparatus for making a hydraulic connection between the tray, the mechanical interface element and the beverage apparatus. The mechanical interface element is removably connected to the body of the tray. The hydraulic coupling apparatus is configured to accommodate a variation of the height position of the tray as a function of the size of the cups. The hydraulic coupling apparatus couples the discharge fitting of the funnel of the body with the mechanical interface element and with the beverage apparatus.

The present invention relates to a tray assembly for apparatuses for preparing coffee, milk and infusion-based beverages.

More in particular, the present invention refers to a tray assembly for the collection and/or discharge of fluids in professional and non-professional apparatuses for preparing beverages and recipes based on coffee, milk and infusions for use in premises or commercial establishments such as bars, cafés, restaurants, private homes, offices and the like.

As is known, in the sector of apparatuses for preparing beverages based on coffee, milk and infusions, the tray is a component with a dual function of collection and/or discharge of fluids and support for a cup which must contain the beverage dispensed by the preparation/dispensing apparatus.

The tray is a component consisting of an assembly comprising a pan made of metal or plastic material, also called a “funnel”, which may or may not be provided with an integrated discharge, a grille made of metal or plastic material (with a shape, for example, of perforated sheet metal) made in a single piece or in several pieces and coupled to the pan (“funnel”) , a possible discharge fitting (if it is not integrated in the pan), a body or coating made of metal or plastic material, gaskets and any support brackets.

What is known as the “funnel” has the function of collecting the discharge coming from the preparation/dispensing apparatus, the grille has the function of providing a support surface for the cups to be filled without hindering the passage of fluids in the direction of the funnel, the discharge fitting (if present) serves to interface the pan with the hydraulic part which goes to the discharge, the body has a purely aesthetic function and, at the same time and depending on the types of apparatus, it also has a safety function depending on the type of funnel, the brackets (when present) have the function of defining a mechanical interface with the apparatus for the preparation/dispensing of beverages.

As previously described, the tray also has the function of defining a support for a cup which must contain the beverage dispensed by the beverage preparation apparatus, with said cup which, to ensure correct filling, must be positioned near the beverage dispensing means (in order to avoid spills of dispensed beverage or splashes or the like) and, for this purpose, many known solutions are adopted.

For example, dispensing apparatuses made in different versions or models according to the use of short cups or tall cups are known; however, such embodiments have significant drawbacks related to the need to make different models of dispensing apparatuses as a function of the type of cups and this entails an increase in production costs as well as the need, on the part of the users of such apparatuses, to find and/or study solutions to be able to meet all the requests regarding different cup heights.

To cope with such a drawback, dispensing apparatuses have been made which comprise retractable shelves, tilters or compensating elements of the different height of the cups and the like.

However, such solutions also have drawbacks related to cleaning difficulties or a pejorative alteration of the design of the dispensing apparatus.

Other known solutions comprise a tray mounted with respect to adjustable brackets stabilized to the tray and to the structure of the dispensing apparatus which allow to vary the height position of the tray in order to compensate for the different cup heights; however, such solutions are, in addition to being complex from a constructive point of view, difficult to use for an operator (for example, in the case of large dispensing apparatuses, the adjustment of the tray height can be difficult to implement by a single operator).

Further solutions comprise a tray whose grille comprises movable articulated plates to be able to manage the different cup heights.

However, all these solutions have drawbacks related to greater production difficulty, greater difficulties in use, maintenance and cleaning and higher production costs.

The aim of the present invention is to overcome the drawbacks set forth above.

More specifically, the aim of the present invention is to provide a tray assembly for apparatuses for preparing coffee, milk and infusion-based beverages such as to solve the problem of managing different cup heights in a flexible manner (to allow a customization of the preparation/dispensing apparatus) and such as to preserve, if not improve, the aesthetic aspect of the dispensing apparatus itself.

A further aim of the present invention is to provide a tray assembly for apparatuses for preparing beverages which is of a modular type.

A further aim of the present invention is to provide a tray assembly for apparatuses for preparing beverages which is easy to use, clean and maintain by a user.

A further aim of the present invention is to provide a tray assembly for apparatuses for preparing beverages which is adapted to allow an optimization of the apparatus and component storage warehouse.

A further aim of the present invention is to provide users with a tray assembly for apparatuses for preparing coffee, milk and infusion-based beverages which is adapted to ensure high reliability and durability over time and such that it can be easily and economically created.

These and other aims are achieved by the invention having the features referred to in claim 1.

According to the invention, a tray assembly is provided for apparatuses for preparing coffee, milk and infusion-based beverages defining a support for cups and a fluid collection and/or discharge, comprising a tray comprising a box-like element or body housing a funnel provided with a discharge fitting and a grille placed closing above the funnel a mechanical interface element applied to a beverage dispensing apparatus, mechanical coupling means and possible magnetic coupling means for a removable connection between said box-like element or body and said mechanical interface element and hydraulic coupling means for a hydraulic connection between the tray, the mechanical interface element and the beverage dispensing apparatus, said means suitable for a variation of the height position of said tray as a function of the size of the cups.

Advantageous embodiments of the invention appear from the dependent claims.

The constructive and functional features of the tray assembly for apparatuses for preparing coffee, milk and infusion-based beverages of the present invention can be better understood from the following detailed description in which reference is made to the attached drawings which represent a preferred and non-limiting embodiment and in which:

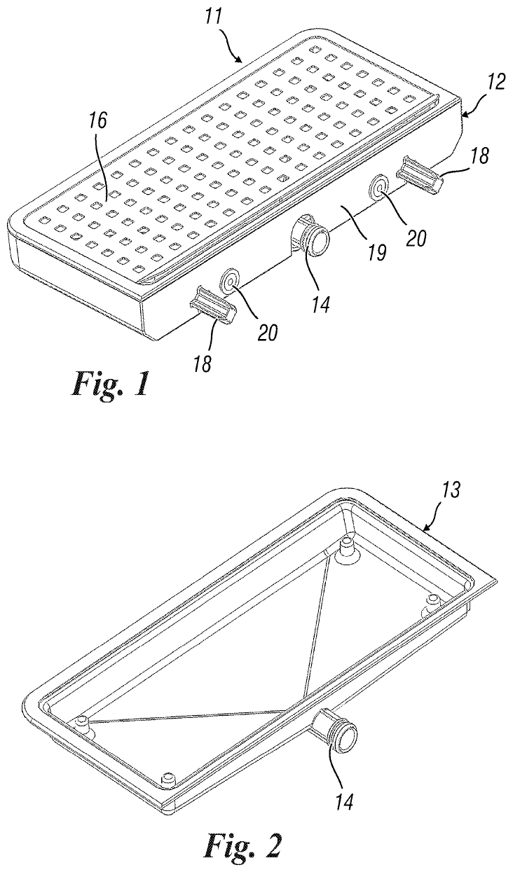

FIG. 1 schematically illustrates an axonometric view of a first element of the tray assembly for apparatuses for preparing coffee, milk and infusion-based beverages of the present invention;

FIG. 2 schematically illustrates an axonometric view of a component of said first element of said tray assembly;

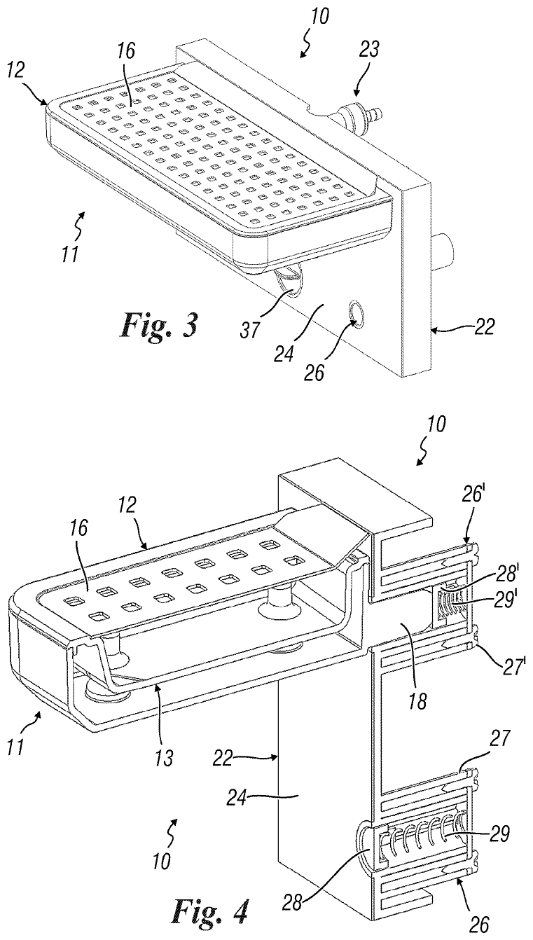

FIG. 3 schematically illustrates an axonometric view of the tray assembly of the invention in accordance with a first embodiment;

FIG. 4 schematically illustrates a section according to a first vertical plane of the assembly of FIG. 3;

FIG. 5 schematically illustrates a further section according to a second vertical plane of the assembly of FIG. 3;

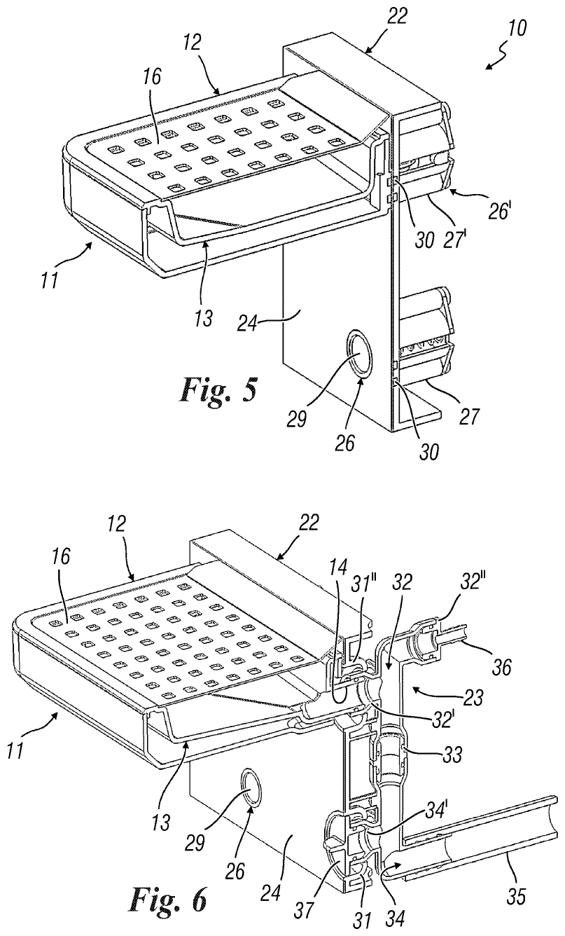

FIG. 6 schematically illustrates a section according to a third vertical plane of the assembly of FIG. 3;

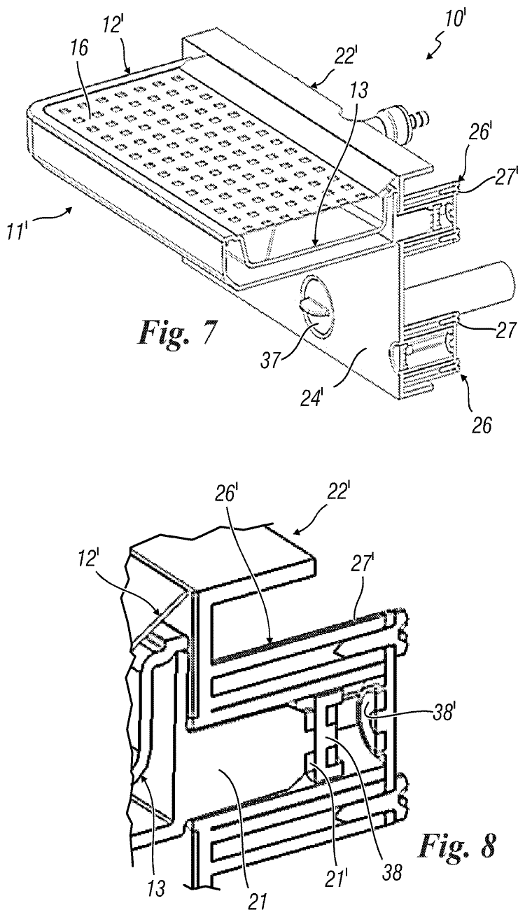

FIG. 7 schematically illustrates a partially sectioned axonometric view of an alternative embodiment for a tray assembly of the invention;

FIG. 8 illustrates a sectional detail of the assembly of FIG. 7;

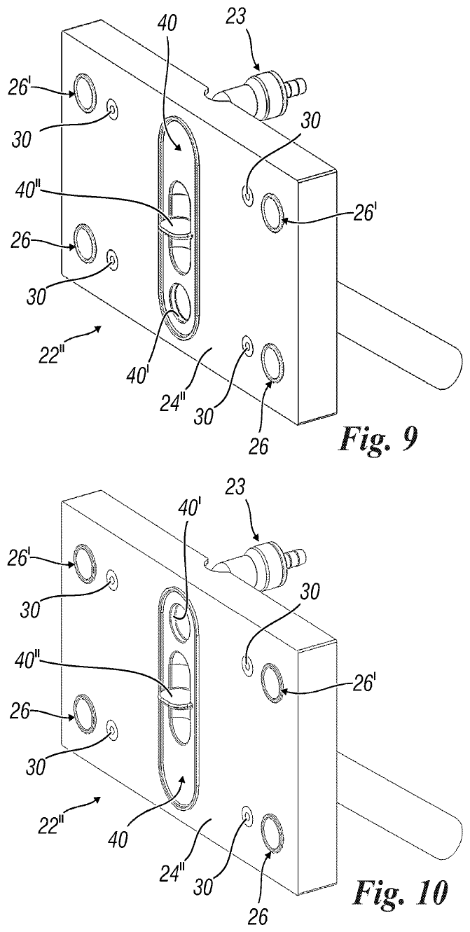

FIGS. 9 and 10 schematically illustrate an axonometric view of a component of the tray assembly of the invention according to an alternative embodiment and in accordance with two operating configurations;

FIG. 11 schematically illustrates a sectional view (according to a vertical plane) of the component of FIGS. 9 and 10;

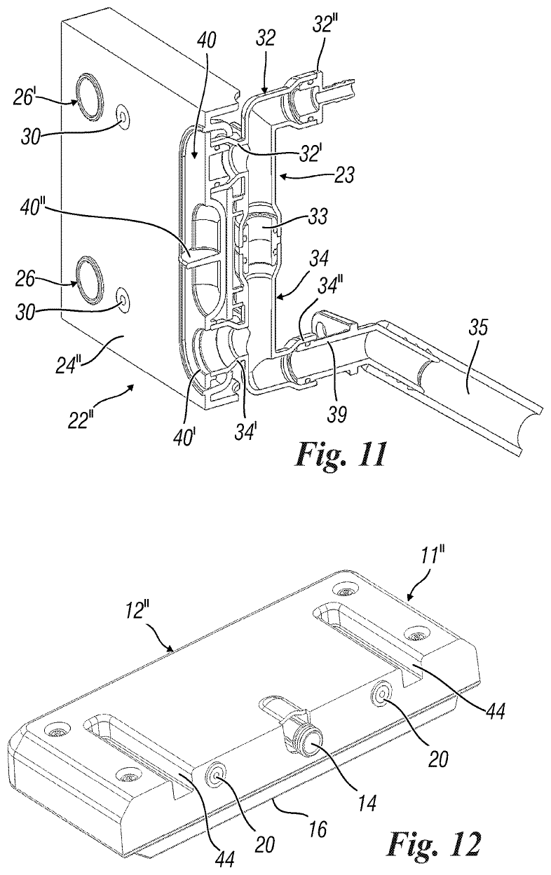

FIG. 12 schematically illustrates a component of the tray assembly of the invention according to a further alternative embodiment;

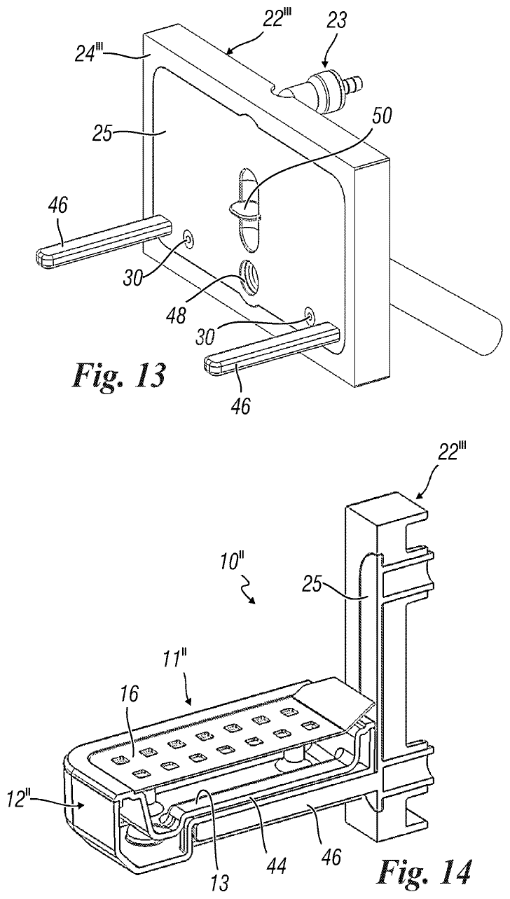

FIG. 13 schematically illustrates an axonometric view of a component of the tray assembly in accordance with the embodiment of FIG. 12;

FIG. 14 schematically illustrates a sectional view of the tray assembly according to the embodiment of FIGS. 12 to 13;

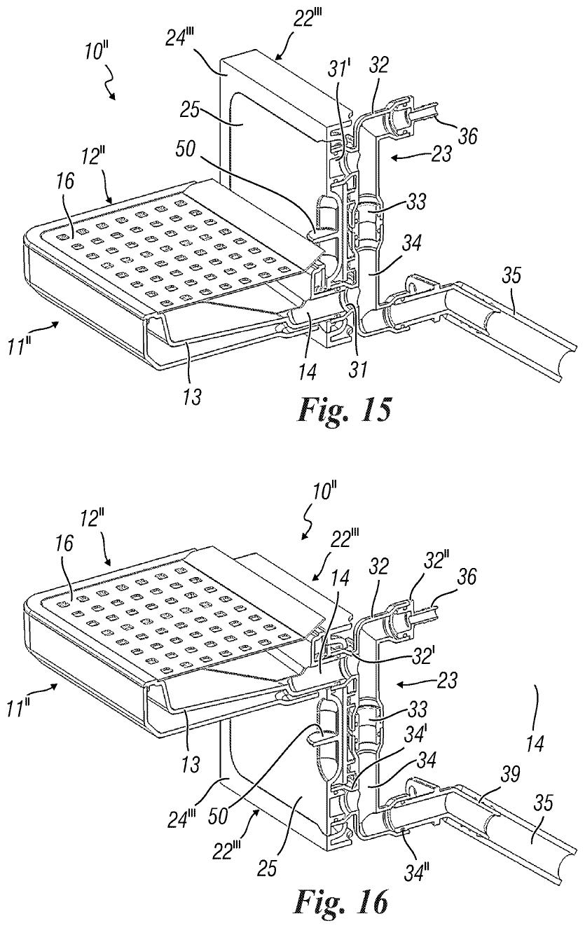

FIGS. 15 and 16 schematically illustrates sectional views of the tray assembly of the invention according to two use/coupling configurations in accordance with the embodiment of FIGS. 12 to 14.

With reference to the aforementioned figures, the tray assembly for apparatuses for preparing coffee, milk and infusion-based beverages of the present invention, comprises several components of which one is defined by a box-like element 12 or body housing a funnel 13 provided with a discharge fitting 14 and a grille 16 placed closing above the funnel 13 and defining a support for cups to be filled with the beverage dispensed by the dispensing apparatus and, at the same time, defining a means which favours the fall of any liquids into the funnel 13 below; the box-like element or body 12, the funnel 13 and the grille 16, when coupled together as described, constitute a tray 11.

The box-like element or body 12 comprises a pair of opposite appendices 18 protruding externally with respect to a front 19 of said box-like element or body 12 (with said appendices 18 extending on the same front from which the discharge fitting 14 of the funnel 13 protrudes when said funnel is coupled to the box-like element or body) which defines the contact front with the beverage dispensing apparatus (not shown) as better described below; the appendices 18 are constrained to the box-like element or body 12 in a known manner (gluing, screws or equivalent retaining means and the like) or are made in a single body with the box-like element or body 12 itself.

The box-like element or body 12 can also comprise magnetic elements or ferromagnetic inserts 20 stabilized at the front 19 of said box-like element or body 12 (with reference to the embodiment of the figures, said magnetic elements or ferromagnetic inserts 20 are two and opposite each other).

The box-like element or body 12 and the funnel 13 can be two separate elements constrained to each other or can be made in a single body.

The tray assembly comprises a further component defined by a mechanical interface element 22 to which the tray 11 is connected, which is coupled with the beverage dispensing apparatus and which comprises, as better detailed below, both mechanical and hydraulic connection means.

The mechanical interface element 22 is provided with hydraulic connection means 23 (better described below) with respect to the tray 11 and the beverage dispensing apparatus and mechanical connection means with the tray 11.

The mechanical coupling means of the mechanical interface element 22 with the tray 11 consist of a lower pair of connections 26 and an upper pair of connections 26′ formed on a front face 24, respectively, at a lower edge and an upper edge of the mechanical interface element 22 and which are functional for coupling, as better detailed below, with the appendices 18 of the box-like element or body 12 of the tray 11 to define a low or high height positioning, respectively, of the tray with said mechanical interface element.

With reference to FIG. 4, the pairs of connections 26 and 26′ of the mechanical interface element 22 comprise, respectively, lower 27 and upper 27′ openings formed starting from the external front 24 and extending in the opposite direction to the coupling direction with respect to the tray 11 and housing, respectively, lower 28 and upper 28′ sliders and lower 29 and upper 29′ elastic elements coupled to the sliders and functional to a sliding movement of said sliders inside said openings 27 and 27′ and with said sliders also defining a cap or closing element for the openings disclosed when the tray 11 is not coupled to the interface element 22 at the pair of lower 27 or upper 27′ openings with the elastic elements which, exerting a pressure on said lower 28 or upper 28′ sliders, bring them to a position substantially flush with the front face 24 of the mechanical interface element 22 to achieve a closure of the aforementioned openings 27 and 27′.

As can be seen from the detail of the section of FIG. 4, when the tray 11 is coupled and made integral with the mechanical interface element 22, the appendices 18 of the box-like element or body 12 engage with the pairs of lower or upper openings 27 or 27′, pushing the lower or upper sliders 28 or 28′ in translation inside the disclosed openings and compressing the lower or upper elastic elements 29 or 29′.

The sliders 28 and 28′ also have a cap function closing the unused openings 27 and 27′ (for example, with reference to FIGS. 3 and 4, the tray 11 is coupled to the mechanical interface element in an upper position, i.e., it is coupled with the upper openings 27′, with the lower openings 27 closed by means of the lower sliders 28 due to the pushing action of the lower elastic elements 29 which maintains said sliders substantially flush with the outer front 24).

The coupling between the box-like element or body 12 and the mechanical interface element 22 also comprises the contribution of any magnetic elements or ferromagnetic inserts 20 of the box-like element or body 12 which couple with corresponding magnets or ferromagnetic inserts 30 of the mechanical interface element 22 (with said magnetic elements arranged at the lower pair of connections 26 and the upper pair of connections 26′ of the mechanical interface element).

The hydraulic connection between the box-like element or body 12 and the mechanical interface element 22 is made through the hydraulic connection means 23 of the mechanical interface element which couple with the discharge fitting 14 of the funnel 13 of the box-like element or body 12.

The hydraulic connection means 23 comprise a lower coupling opening or compartment 31 and an upper coupling opening or compartment 31′ formed on the mechanical interface element 22 and functional to accommodate the discharge fitting 14 of the funnel 13 (as a function of the positioning height of the box-like element or body), a first interface fitting 32 connected to said upper coupling opening or compartment 31′ by means of a first connection 32′ which, by means of a joint 33, connects to a second interface fitting 34 connected to said lower coupling opening or compartment 31 by means of a first connection 34′ and which connects to a discharge tube 35 of the beverage dispensing apparatus and with the interface fitting 32 which, by means of a second connection 32″, connects with an adapter 36 with the function of discharging other tubes of the hydraulic system of the beverage dispensing apparatus.

Furthermore, the hydraulic connection means 23 comprise a cap 37 with the function of closing the coupling opening or compartment (lower 31 upper 31′) which is not used, depending on the positioning of the box-like element or body with respect to the mechanical interface element 22.

With reference to FIGS. 7 and 8, an alternative embodiment for the tray assembly (indicated with 10′) is illustrated which has the same features as those of the tray assembly of the previously disclosed embodiment and differs with reference to the mechanical coupling means with respect to the mechanical interface element (therefore, the details shared with the previously disclosed embodiment will be indicated with the same reference number).

With reference to such an embodiment, the pair of opposite appendices 21 protruding externally with respect to the box-like element or body 12′ of the tray 11′ each comprise a magnet 21′ fixed to the free end of said appendices 21 and adapted to cooperate with the mechanical connection means of the mechanical interface element 22′ comprising a first magnet 38 and a second magnet 38′, with the first magnet 38 sliding inside the lower 27 and upper 27′ openings of the lower pair of connections 26 and of the upper pair of connections 26′ and with the second magnet 38′ fixed with respect to the same lower 27 and upper 27′ openings.

The first magnet 38 cooperates with the magnet 21′ of the appendices 21 of the box-like 12′ and with the second magnet 38′; in fact, upon the coupling between the tray 11′ and the mechanical interface element 22′, the magnet 21′ couples with the first magnet 38 which, in turn, couples with the second magnet 38′.

Upon the decoupling between the tray 11′ and the mechanical interface element, the first magnet 38 slides inside the lower 27 and upper 27′ openings to close the lower pair of connections 26 and the upper pair of connections 26′.

In accordance with an alternative embodiment, the lower pair of connections 26 and the upper pair of connections 26′ can be closed by means of closing plugs with manual application.

FIGS. 9 to 11 illustrate an alternative embodiment for the mechanical interface element (indicated with 22″) and, more in particular, for the hydraulic connection means comprising a cap 40 applied to a front face 24″ of the mechanical interface element 22″ closing the lower 31 or upper coupling compartment 31′; said cap 40 has a plate-like extension and comprises a through hole 40′ (with dimensions corresponding to those of the lower or upper coupling compartment) and an externally protruding gripping element 40″ and adapted to define a gripping element by a user in accordance with what is better disclosed below.

The cap 40 enables/disables the use of the lower 31 or upper coupling compartment 31′ of the interface element as a function of the coupling mode of the tray, with said enabling/disabling being implemented by detaching, by means of the gripping element 40″, the cap 40 from the coupling with the mechanical interface element 22′ and rotating it by 180° in order to couple the through hole 40′ with the lower coupling compartment 31 or with the upper coupling compartment 31′ as a function of the positioning needs of the tray 11; FIG. 9 illustrates the configuration in which the tray engages in a low position with the discharge fitting which engages with the lower coupling compartment 31, while FIG. 10 illustrates the configuration in which the tray engages in a high position with the discharge fitting which engages with the upper coupling compartment 31′, and this in order to allow the coupling of the discharge fitting 14 thereof with the hydraulic coupling means 23 which, as disclosed above, comprise a first interface fitting 32 connected to said upper coupling opening or compartment 31′ by means of a first connection 32′ and which, by means of a joint 33, is connected to a second interface fitting 34 connected to said lower coupling opening or compartment 31 by means of a first connection 34′ and which is connected to a discharge tube 35 of the beverage dispensing apparatus by means of an intermediate fitting 39 connected to said second interface fitting by means of a second connection 34″ and to the first interface fitting 32 which, by means of a second connection 32″, is connected to an adapter 36 with the function of discharging other tubes of the hydraulic system of the beverage dispensing apparatus.

In accordance with an alternative embodiment, the enabling/disabling of the use of the lower or upper coupling compartment 31 or 31′ of the interface element as a function of the coupling mode of the tray, can be implemented by means of a manually operated lever, vertically movable and adapted to control a sliding movement of a door (or plate-like element) which will open or close, alternately and as a function of the positioning of the tray, the upper or lower coupling hole.

An alternative embodiment for the tray assembly is illustrated with reference to FIGS. 12 to 14.

It comprises a tray 11″ comprising a box-like element or body 12″ which houses a funnel 13 provided with a discharge fitting 14 and a grille 16 placed closing the funnel 13 and defining a support surface for cups to be filled with the beverage dispensed by the dispensing apparatus and, at the same time, defining a means for collecting and conveying liquid residues to the funnel 13 below.

Said box-like element or body 12″, on a lower base 12″′ on the opposite side with respect to that housing the funnel 13 and the grille 14, comprises a pair of parallel and opposite recesses 44 defining a seat for corresponding opposite and parallel clamps or brackets 46 protruding externally with respect to a component 25 coupled to the mechanical interface element 22″′ at a front face 24″′ thereof, with said component 25 also comprising magnets or ferromagnetic inserts 30 for a coupling with corresponding (and any) magnetic elements or ferromagnetic inserts 20 of the box-shaped element or body 12″ and a coupling opening or compartment 48 for the discharge fitting 14 of the funnel 13 of the box-shaped element or body 12″ and for a coupling of said discharge fitting 14 with the lower coupling opening or compartment 31 or with the upper coupling opening or compartment 31′ of the mechanical interface element 22″′ (as diagrammatically shown in FIGS. 15 and 16), a gripping element 50 for varying the position of the component 25 in order to vary the configuration in height positioning of the box-like element or body 12″.

FIG. 14 illustrates the coupling between the tray 11″ and the mechanical interface element 22″′.

The variation of the height position of the tray 11″ as a function of the type of cup is achieved by rotating the component 25 of the mechanical interface element by 180° as diagrammed in FIGS. 15 and 16 which illustrate, respectively, a lower and upper coupling of the tray 11″ with respect to the interface element and, therefore, a low or high positioning of the box-like element or body as a function of the use, for example of a small cup and of a cup or container with a greater height with respect to the standard cup height; the rotation of the component 25 determines, for example, the disabling of the coupling of the lower coupling opening or compartment 31 and the enabling of the coupling of the upper coupling opening or compartment 31′.

The above-described tray in accordance with its embodiments can be sized as a function of the number of beverage dispensing elements of the dispensing apparatus (for example, a single tray for two or more dispensing elements) or can be single and dedicated to a single dispensing element (so as to define the height of the tray independently for each dispensing element as, for example, in the case of a modular dispensing apparatus comprising two or more modules dedicated to dispensing different types of beverages).

As can be seen from the above, the advantages obtained by the object of the invention are clear.

The tray assembly for apparatuses for preparing coffee, milk and infusion-based beverages of the present invention advantageously allows to solve the problem of managing different cup heights in a flexible manner, allowing a customization of the preparation/dispensing apparatus and, in addition, to preserve, if not improve, the aesthetic appearance of the dispensing apparatus.

A further advantage of the tray assembly of the invention is represented by an easy use, cleaning and maintenance by a user; in fact, the disclosed tray can be quickly, simply and effortlessly decoupled and coupled with respect to the beverage dispensing apparatus.

A further advantage of the tray assembly of the invention is that it allows an optimization of the warehouse, as it is not necessary to have different trays for different positioning heights.

Although the invention has been described above with particular reference to embodiments thereof given only by way of non-limiting example, numerous modifications and variations will be apparent to a person skilled in the art in the light of the above description. Therefore, the present invention intends to embrace all the modifications and variations which fall within the scope of the following claims.

1-10. (canceled)

11. A tray assembly for beverage apparatus for preparing and dispensing coffee, milk and infusion-based beverages, the tray assembly defining a support for cups and being configured for fluid collection and/or discharge and comprising:
a tray having a body that houses a funnel with a discharge fitting and a grille disposed over the funnel,
a mechanical interface element for connection to the beverage apparatus, the mechanical interface element being removably connected to said body of the tray, and
a hydraulic coupling apparatus for making a hydraulic connection between the tray, the mechanical interface element and the beverage apparatus, the hydraulic coupling apparatus being configured to accommodate a variation of the height position of said tray as a function of the size of the cups, wherein the hydraulic coupling apparatus couples the discharge fitting of the funnel of the body with the mechanical interface element and with the beverage apparatus.

12. The tray assembly according to claim 11, wherein the hydraulic coupling apparatus is mounted to the mechanical interface element.

13. The tray assembly according to claim 12, wherein the body of the tray comprises a pair of appendices protruding externally with respect to a front of said body, and wherein the mechanical interface element comprises mechanical connectors that cooperate with the appendices of the body of the tray, the mechanical connectors comprising a lower pair of connectors and an upper pair of connectors formed, respectively, at a lower edge and at an upper edge of a front face of the mechanical interface element and comprising, respectively, lower and upper openings which house, respectively, lower and upper sliders and lower and upper elastic elements coupled to said lower and upper sliders, the lower and upper sliders being slidable inside said lower and upper openings, respectively.

14. The tray assembly according to claim 12, wherein the body of the tray comprises a pair of appendices protruding externally form the body, each of the appendices having a free end with a magnet fixed thereto, and wherein the mechanical interface element comprises mechanical connectors that cooperate with the appendices of the body of the tray, the mechanical connectors comprising a lower pair of connectors and an upper pair of connectors formed, respectively, at a lower edge and at an upper edge of a front face of the mechanical interface element and comprising, respectively, lower and upper openings and pairs of first and second magnets disposed therein, a pair of first and second magnets being disposed in each of the lower and upper openings, with the first magnets being slidable inside the lower and upper openings, respectively, and the second magnets being fixed inside the lower and upper openings, respectively, and wherein the first magnets cooperate with the magnets of the appendices of the body and the second magnets of the mechanical interface element.

15. The tray assembly according to claim 12, wherein the body of the tray comprises, on a lower base, a pair of parallel and opposite recesses defining seats for corresponding opposite and parallel clamps protruding from a component coupled to a front face of the mechanical interface element.

16. The tray assembly according to claim 12, wherein the hydraulic coupling apparatus comprises:
a lower coupling compartment and an upper coupling compartment configured to accommodate the discharge fitting of the funnel;
a first interface fitting connected to the upper coupling compartment and to an adapter;
a second interface fitting connected to the lower coupling compartment and to a discharge tube of the beverage apparatus; and
wherein the adapter is for connection to other discharge tubes of the beverage apparatus.

17. The tray assembly according to claim 16, wherein the body of the tray comprises, on a lower base, a pair of parallel and opposite recesses defining seats for corresponding opposite and parallel clamps protruding from a component coupled to a front face of the mechanical interface element;
wherein the component of the mechanical interface element comprises a coupling compartment for a coupling of the discharge fitting of the funnel of the tray and for a coupling of said discharge fitting with the lower coupling compartment or with the upper coupling compartment of the hydraulic coupling apparatus, the component being rotatable by 180° for a low or high coupling of the body of the tray with respect to the mechanical interface element with an enabling/disabling of the lower coupling compartment or of the upper coupling compartment for the connection of the discharge fitting as a function of the position of the body.

18. The tray assembly according to claim 17, wherein the body of the tray has magnets configured to couple with corresponding magnets of the mechanical interface element.

19. The tray assembly according to claim 17, further comprising a cap for closing the one of the lower coupling compartment and the upper coupling compartment that is not being used according to the positioning of the tray with respect to the mechanical interface element.

20. The tray assembly according to claim 19, wherein the cap has a plate-like extension and comprises a through hole and a gripping element protruding externally and configured to define a gripping element for use by a user for enabling/disabling the lower coupling compartment or the upper coupling compartment as a function of the chosen height position for the body of the tray with a rotation of 180°.

21. A tray assembly for use with a beverage apparatus for preparing and dispensing a beverage, the tray assembly comprising:
a mechanical interface element for connection to the beverage apparatus;
a tray removably mounted to the mechanical interface element, the tray including a grille and a body having a funnel disposed therein, the grille being disposed over the funnel and providing a support for a cup to be filled with the beverage, the grille being configured to allow spilled beverage to pass therethrough into the funnel, the funnel having a discharge fitting;
a hydraulic coupling apparatus for connecting the discharge fitting of the funnel to a discharge outlet of the beverage apparatus to permit spilled beverage in the funnel to flow to the discharge outlet of the beverage apparatus;
wherein the mechanical interface element and the tray are configured to have the tray mounted to the mechanical interface element so as to be in a lower position or an upper position relative thereto in order to accommodate different-sized cups, wherein one of the mechanical interface element and the tray have appendices extending therefrom and the other one of the mechanical interface element and the tray have recesses or openings formed therein that are configured to receive the appendices to mount the tray to the mechanical interface element, and wherein the mechanical interface element and the tray are configured to permit the height of the appendices relative to the recesses or openings receiving the appendices to be changed to change a mounting position of the tray between the lower position and the upper position; and
wherein the hydraulic coupling apparatus is configured to connect the funnel to the discharge outlet when the tray is in either the lower position or the upper position.

22. The tray assembly of claim 21, wherein the hydraulic coupling apparatus comprises:
a lower coupling compartment and an upper coupling compartment, each of which is configured to connect to the discharge fitting of the funnel;
a first interface fitting connected to the upper coupling compartment; and
a second interface fitting connected to the lower coupling compartment and to the discharge tube of the beverage apparatus; and
a joint connecting the first interface fitting to the second interface fitting; and
wherein when the tray is in the upper position, the discharge fitting of the funnel is connected to the upper coupling compartment of the hydraulic coupling apparatus, and when the tray is in the lower position, the discharge fitting of the funnel is connected to the lower coupling compartment of the hydraulic coupling apparatus.

23. The tray assembly of claim 21, wherein the body of the tray has the appendices extending therefrom, and the mechanical interface element has a pair of upper openings and a pair off lower openings formed therein, each of which is configured to receive the appendices; and
wherein when the tray is in the upper position, the appendices of the body are disposed in the upper openings of the mechanical interface element, and when the tray is in the lower position, the appendices of the body are disposed in the lower openings of the mechanical interface element.

24. The tray assembly of claim 21, wherein a bottom side of the body of the tray has a pair of recesses formed therein for receiving the appendices to have the tray supported on the appendices;
wherein the mechanical interface element has a rotatable plate with the appendices extending therefrom, the appendices being disposed toward an edge of the plate, the plate being rotatable 180° between an upper position in which the edge of the plate is facing upwardly and a lower position in which the edge of the plate is facing downwardly; and
wherein when the tray is in the upper position, the plate of the mechanical interface element is in the upper position and when the tray is in the lower position, the plate of the mechanical interface element is in the lower position.
